(19) United States
(12) Patent Application Publication
(10) Pub. No.: US 2015/0010087 A1
(43) Pub. Date: Jan. 8, 2015

(54) Image Processing Method and Apparatus

(71) Applicant: Parabola Research Limited, Southampton (GB)

(72) Inventor: John Funnell, Southampton (GB)

(21) Appl. No.: 14/322,156

(22) Filed: Jul. 2, 2014

Related U.S. Application Data
(60) Provisional application No. 61/843,074, filed on Jul. 5, 2013.

(51) Int. Cl. H04N 19/176

(52) U.S. Cl. CPC H04N 19/00278
USPC 375/240.24

(57) ABSTRACT

An image processing method is described, which comprises processing a current block of image data and generating a parameter value required to process one or both of a horizontally adjacent block of image data and a vertically adjacent block of image data, and storing the parameter value into a parameter memory. The parameter memory comprises a memory element for each of a plurality of horizontal block positions in an image, and/or a memory element for each of a plurality of vertical block positions in the image. A parameter value generated from a block of image data is stored to overwrite one or both of a previous parameter value generated from another block of image data at the same horizontal position as the current block, and a previous parameter value generated from another block of image data at the same vertical position as the current block. It has been recognized that, due to the predetermined order in which blocks of image data are required to be processed, and the relative proximity of interdependent blocks, it is not necessary to keep parameter data in relation to all previously processed blocks. Moreover, it has been recognized that, in relation to a particular horizontal position (column) it is only necessary to retain generated parameters from the most recently processed block at that horizontal position, and that in relation to a particular vertical position (row) it is only necessary to retain generated parameters from the most recently processed block at that vertical position. As a result, the amount of memory which needs to be allocated to storing parameter values from processed blocks of image data can be dramatically reduced.

### CROSS-REFERENCE TO RELATED APPLICATIONS

This application claims the priority of provisional U.S. patent application entitled “Image Processing Method and Apparatus,” filed Jul. 5, 2013, having Ser. No. 61/843,074, the disclosure of which is hereby incorporated by reference in its entirety.

### FIELD OF THE INVENTION

The present invention relates to an image processing method, and to an image processing apparatus. Embodiments of the present invention relates to an image processing method and apparatus in which more efficient use is made of memory resources. More particularly, embodiments of the present invention relate to video coding and in particular to the use of a neighbouring block values memory for video coding to store syntax elements, variables and other values needed during video frame compression or decompression processes.

### BACKGROUND TO THE INVENTION

Digital video compression finds a wide range of applications in a variety of devices including televisions, smart phones, PCs, laptops, cameras and video conferencing devices. These devices implement video compression encoding and decoding techniques defined in standards such as HEVC (High Efficiency Video Encoding) and H.264. Such standards divide digital video frames into square or rectangular picture regions known as ‘blocks’. The way pictures are spatially subdivided is specified in the standard. Video frames are divided into CTUs (Coding Tree Units) or macroblocks which are conventionally processed in a raster scan order. CTUs are subdivided into multiple sub-blocks and divided again as necessary and permitted by the standard. This spatial subdivision defines the order in which child blocks should be processed. The smallest block that may be processed is a single image pixel; that is to say a spatial sample value representing luminance, chrominance or the colour value at that point of the image or video frame.

To achieve good coding performance, video coding standards require the decoder to retain and later use information from previously decoded blocks in the same frame. Commonly, a decoder must make calculations or decisions based upon values or attributes of neighbouring blocks that have already been decoded. Because video encoders need to maintain a record of anticipated decoder state, encoders also must do likewise.

Video coding encoders and decoders commonly process data spatially segmented into slices and/or tiles. A slice or tile is a picture region that can be decoded independently of other slices or tiles. At the left and top boundaries of a slice or tile, spatial neighbour predictors are unavailable so additional logic is defined in video compression standards to achieve deterministic behaviour in these cases. Similarly, at the top, bottom, left and right borders of an image, spatial neighbours are unavailable, again requiring additional logic.

Embodiments of the present invention seek to address these problems.

### SUMMARY OF THE INVENTION

According to an aspect of the present invention, there is provided an image processing method, comprising:

processing a current block of image data and generating a parameter value required to process one or both of a horizontally adjacent block of image data and a vertically adjacent block of image data; and

storing the parameter value into a parameter memory, the parameter memory comprising a memory element for each of a plurality of horizontal block positions in an image, and/or a memory element for each of a plurality of vertical block positions in the image, wherein a parameter value generated from a block of image data is stored to overwrite one or both of a previous parameter value generated from another block of image data at the same horizontal position as the current block, and a previous parameter value generated from another block of image data at the same vertical position as the current block.

It has been recognized that, due to the predetermined order in which blocks of image data are required to be processed, and the relative proximity of interdependent blocks, it is not necessary to keep parameter data in relation to all previously processed blocks. Moreover, it has been recognized that, in relation to a particular horizontal position (column) it is only necessary to retain generated parameters from the most recently processed block at that horizontal position, and that in relation to a particular vertical position (row) it is only necessary to retain generated parameters from the most recently processed block at that vertical position. As a result, the amount of memory which needs to be allocated to storing parameter values from processed blocks of image data can be dramatically reduced.

In most cases a block will be a group of spatially adjacent pixels, for example a 2 by 2 block of pixels or a 4 by 4 block of pixels. However, in some cases a block may be a single pixel and a parameter value may be the processed (e.g. decoded), output value of that pixel.

While in some implementations a single array may be used to store the most recent parameter values deriving from one or both of rows and columns of blocks, preferably a first one dimensional array memory and a second one dimensional array memory are used to store parameter values. In this case, the step of storing may comprise storing the parameter value into a first one dimensional memory array and a second one dimensional memory array of the parameter memory, the parameter value being stored into the first one dimensional memory array at one or more positions corresponding to the horizontal position of the current block, and being stored into the second one dimensional memory array at one or more positions corresponding to the vertical position of the current block. With this arrangement the first one dimensional memory array may be considered as a “horizontal memory array” which stores, in relation to each horizontal block position of the image, a parameter value of the most recently processed block at that horizontal position. Similarly, the second one dimensional memory array may be considered as a “vertical memory array” which stores, in relation to each vertical block position of the image, a parameter value of the most recently processed block at that vertical position. This is highly convenient, since each new processing block can be expected to overwrite parameter data from one or both of a horizontally adjacent block (updated in the first one dimensional memory array) and a vertically adjacent block (updated in the second one dimensional memory array). In this way, a neighboring block value memory for a video coding device is provided comprising a one-dimensional horizontal array of lowermost available values of each column of blocks and a one-dimensional vertical array of rightmost available values of each row of blocks.

The horizontal position of the current block may be its horizontal position within an image (i.e. the whole image) or within a portion (e.g. a tile or a slice) of the image, and the vertical position of the current block may be its vertical position within the image or within the portion of the image. The first one dimensional memory array and the second one dimensional memory array may each be sized to store parameter data for an independently processable region of an image. The parameter memory need only store parameter values which may still be used in future processing. Where a portion of an image is processed independently, such as in the case of a slice or tile, the number of elements in one or both of the first and second one dimensional memory arrays can be less, since all parameter values can be reset before starting on the next independent portion of the image.

An independently processable region of an image is a group of (generally adjacent) pixels which can be processed (e.g. decoded) using only parameter values generated from other pixels within that same region. In other words, parameter values from pixels outside of the region are not required to process any of the pixels within the region. For example, in HEVC, a slice or tile is an independently processable region of an image, enabling an image to be divided into a grid of rectangular regions that can processed (encoded/decoded) independently from each other. The method may then comprise the step of retrieving a parameter value corresponding to a previously processed block which is vertically adjacent to the current block from the first one dimensional memory array and/or retrieving a parameter value corresponding to a previously processed block which is horizontally adjacent to the current block from the second one dimensional memory array. The current block of image data is then processed using the parameter value(s) retrieved from the first one dimensional memory array and/or the second one dimensional memory array.

It will be appreciated that different processes may require parameters from different ones or combinations of horizontal, vertical and diagonal adjacent blocks.

Where diagonally adjacent blocks may be used to generate parameters for subsequent blocks, then the method may comprise the step of retrieving a parameter value corresponding to a previously processed block which is diagonally adjacent to the current block from the first one dimensional memory array or the second one dimensional memory array. The current block of image data is then processed using the parameter value retrieved from the first or second one dimensional memory array.

The step of storing the parameter value generated from the processing of the current block may comprise overwriting in the first one dimensional memory array a previously stored parameter value which corresponds to a previously processed block at the same horizontal position as the current block, and overwriting in the second one dimensional memory array a previously stored parameter value which corresponds to a previously processed block at the same vertical position as the current block. This overwriting reuses the same element of the parameter memory multiple times, and is therefore efficient in terms of memory footprint. This is possible because each element of a memory array represents the most recently processed block at a particular position (i.e. a position relative to a current block) rather than representing an absolute position within an image.

The first one dimensional memory array and the second one dimensional memory array may each be implemented as contiguous data arrays in memory using contiguous address space. This makes storing data into the memory arrays, and retrieving data from the memory arrays, very fast and efficient.

The second one dimensional memory array may be sized to store parameter data for a single row of blocks of the largest block size being processed by the method. This may apply for a raster scan mode, where the second one dimensional memory array is used to obtain a parameter value from a block to the left of the current block. If the blocks are being handled in raster scan order, then the parameter values of interest are all within a range of horizontal positions corresponding to one block of maximum size (and thus multiple blocks of less than the maximum size).

The method may be able to process blocks of different sizes. In this case, each element of the first one dimensional memory array and the second one dimensional memory array corresponds to an image area of size equivalent to the highest common factor of all the block sizes which can be processed by the method. If the current block is larger than this, then the parameter values generated by processing the current image block are stored into a plurality of positions within the first and second one dimensional memory arrays which correspond to the position of the current image block.

In some embodiments, when a parameter value within one or both of the first and second one dimensional memory arrays is to be overwritten, if the parameter value to be overwritten is required in order to process a block which is diagonally adjacent to the block from which the parameter value was generated, the parameter value is copied to a third memory array before being overwritten in the first and/or second one dimensional memory arrays. Parameter values for diagonally adjacent blocks are not required for all purposes, and so the third memory array may only exist in relation to certain parameter types.

The third memory array may be a one dimensional memory array having memory positions which correspond to the horizontal or vertical position of the image block from which the parameter value to be stored in the third memory array was generated.

In some embodiments, the blocks are processed in a raster scan order. In this case, the first one dimensional memory array stores parameter values corresponding to a bottom-most processed block at each horizontal position, and the second one dimensional memory array stores parameter values corresponding to a right-most processed block at each vertical position. A parameter value corresponding to an image block immediately above the current image block is retrieved from the first one dimensional memory array at a position corresponding to the current image block, and a parameter value corresponding to an image block immediately to the left of the current image block is retrieved from the second one dimensional memory array at a position corresponding to the current image block.

Each entry in the first and second one dimensional memory arrays may store a plurality of parameter values corresponding to a plurality of different parameters. This enables a single array to be structured to store multiple parameter values relating to different parameters. This makes retrieval very straightforward, since by addressing a single element or address range in memory corresponding to that single element, it is possible to retrieve in one memory access operation all of the parameter values relating to an image block of interest.

The method may further comprise a step of initializing elements of the parameter memory with a predetermined parameter value before they are used for processing a new independently processable region of an image. This can be particularly important if processing of blocks in a subsequent independently processable region of the image is to attempt to access parameter values from adjacent blocks outside of that region (and inside the original independently processable region). The predetermined value can be set to a value which obviates the requirement to conduct a logical operation to check whether or not there are relevant neighboring cells within the new independently processable region. In other words, the predetermined value can be such that if it is processed as an adjacent block, the processing result is the same as if the current block had been determined not to have a relevant neighbor. In some cases, in the initialization step, the same predetermined parameter is written to all elements of the parameter memory independently of the actual parameter values generated from the blocks of image data which those elements correspond to. The writing of the same value to all elements is efficient in memory access terms. The predetermined value may be below a minimum possible value for the parameter, or above a maximum possible value for the parameter, or be an impermissible value for the parameter, or a null or zero value, or a default value for the parameter, or a previously computed value for the parameter which applies when a block in a new independently processable region of the image is at a border of that region.

According to another aspect of the present invention, there is provided an image processing apparatus, comprising:

a processor operable to process a current block of image data and to generate a parameter value required to process one or both of a horizontally adjacent block of image data and a vertically adjacent block of image data; and

a parameter memory, comprising a memory element for each of a plurality of horizontal block positions in an image, and/or a memory element for each of a plurality of vertical block positions in the image, wherein the parameter memory is configured when storing a parameter value generated from a block of image, to overwrite one or both of a previous parameter value generated from another block of image data at the same horizontal position as the current block, and a previous parameter value generated from another block of image data at the same vertical position as the current block.

According to another aspect of the present invention, there is provided an image processing method, comprising:

initializing to a predetermined value one or more elements of a parameter memory;

in relation to the processing of a current block of image data, retrieving a parameter value from the parameter memory and processing the current block of image data using the retrieved parameter; wherein

the retrieved parameter value is either a value generated from the processing of a spatially adjacent block in a particular direction with respect to the current block, or the initialized predetermined value in a case where there is no spatially adjacent block available in that particular direction within the image or within an independently processable region of the image currently being processed.

In one embodiment, the memory comprises the configuration defined above in relation to the first aspect. In another embodiment, the memory comprises an image processing method in which the parameter memory comprises a two dimensional array of elements having a main part in which each element corresponds to a block of image data in an image, and a border part comprising a row of elements vertically adjacent to the main part and a column of elements horizontally adjacent to the main part; and one or more elements within the border part are initialized in order to permit the processing of a block of pixels at an edge of the image and/or one or more elements within the main part, at a position corresponding to blocks of image data outside of the independently processable region of the image currently being processed, are initialized in order to permit the processing of a block of pixels at an edge of the independently processable region of the image which is adjacent to another independently processable region of the image.

Here, in relation to a first independently processable region of an image, a step of processing blocks of image data and generating and storing into a memory parameter values required to process one or more adjacent blocks of image data within the first independently processable region may be provided. Following this, a step of initializing to a predetermined value elements within the memory which correspond to blocks of image data which are within the first independently processable region of the image and adjacent to a second independently processable region of the image still to be processed may be provided. In relation to the second independently processable region of the image, a step of retrieving the initialized parameter values to process blocks of image data adjacent to the first independently processable region of the image may be provided.

The predetermined value can be set to a value which obviates the requirement to conduct a logical operation to check whether or not there are relevant neighboring cells within the new independently processable region. In other words, the predetermined value can be such that if it is processed as an adjacent block, the processing result is the same as if the current block had been determined not to have a relevant neighbor. In some cases, in the initialization step, the same predetermined parameter is written to all elements of the parameter memory independently of the actual parameter values generated from the blocks of image data which those elements correspond to. The writing of the same value to all elements is efficient in memory access terms. The predetermined value may be below a minimum possible value for the parameter, or above a maximum possible value for the parameter, or be an impermissible value for the parameter, or a null or zero value, or a default value for the parameter, or a previously computed value for the parameter which applies when a block in a new independently processable region of the image is at a border of that region. In this way, by setting initial values at memory locations representing unavailable blocks, a means is provided to avoid the need to test slice and/or tile boundary availability conditions.

### BRIEF DESCRIPTION OF THE DRAWINGS

The invention will now be described by way of example with reference to the following Figures in which:

FIG. 1 schematically illustrates an image processing apparatus;

FIG. 2 schematically illustrates a structure of part of a HEVC video frame being decoded with a superimposed 2-D array of CtDepth values;

FIG. 3 schematically illustrates the same part of a HEVC video frame being decoded as FIG. 2, with corresponding parts of horizontal and vertical 1-D arrays according to one embodiment;

FIG. 4 schematically illustrates a CU being decoded and the new CtDepth value 0 being populated into regions of the 1-D arrays;

FIG. 5 schematically illustrates an embodiment in which a third 1-D “corner” array is used, providing data pertaining to the current block's top-left neighbour;

FIG. 6 schematically illustrates an extended 2-D array of CtDepth values including positions outside of the current slice or tile and initial zero values that are used to avoid the need for boundary availability computation;

FIG. 7 schematically illustrates horizontal and vertical 1-D arrays of CtDepth with initial zero values that are used to avoid the need for boundary availability computation; and

FIG. 8 is a schematic flow diagram of the overall image processing method.

### DETAILED DESCRIPTION OF THE INVENTION

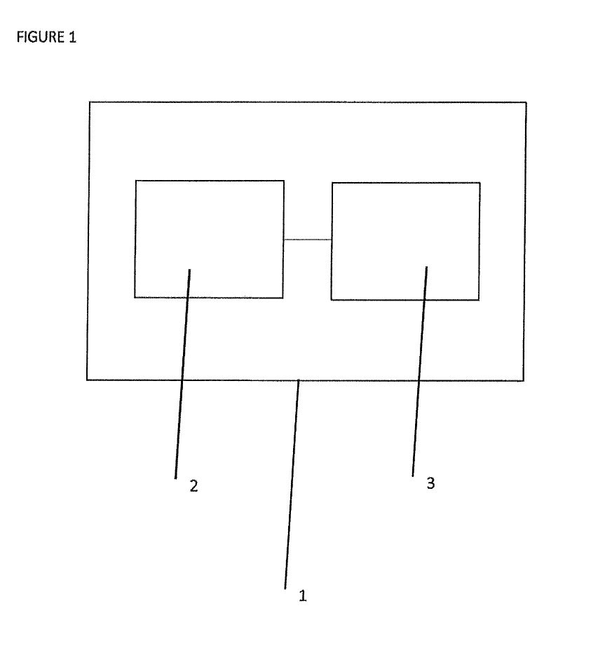

Referring to FIG. 1, an image processing device 1 is provided which comprises a processor 2 and a memory 3 connected to the processor. The processor 2 is able to store data to the memory 3 and retrieve data from the memory 3 in order to be able to process the data. The memory 3 comprises a parameter memory, which is described in detail below. The present disclosure concerns the manner in which block-specific information is stored in memory during the video coding process. It is applicable to various image processing devices such as video decoders, encoders and other stream manipulation devices, and has multiple advantages including reduced memory footprint, reduced memory bandwidth requirements and reduced computational logic.

Video coding devices maintain a memory of previously decoded syntax element values, intermediate values and derived values on a per-block basis. In this description, a “block” is a square or rectangular picture region. By way of example, a HEVC decoder is required to store the value of parameter CtDepth for each coding unit (CU) for later use. CtDepth is a parameter indicating the coding tree depth of a block. A coding unit is a square picture region resulting from HEVC's coding quadtree subdivision. When decoding a coding unit, a decoder must make computations based on the CtDepth values of coding units to the left and above the current coding unit. Conventional decoders maintain a two-dimensional (2-D) array that is populated with CtDepth values as they become available. The 2-D array may be sized such that an element in the array represents the same spatial area as the minimum size coding unit. The 2-D array could be represented in raster order, in quadtree z-order or some other mapping to a linear address space.

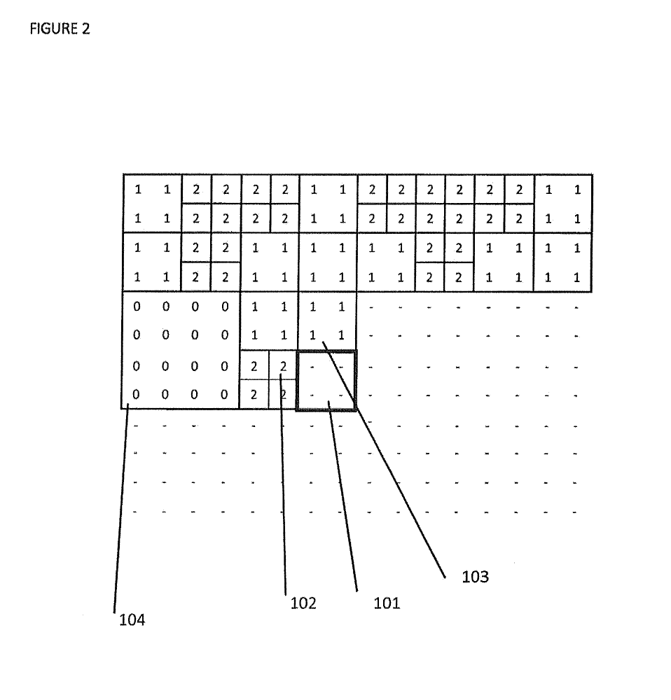

FIG. 2 shows part of a video frame being decoded, a block being processed 101, the CtDepth value of the coding unit to the left 102, the CtDepth value 103 of the coding unit above and all the other previously decoded CtDepth values in a conventional 2-D memory. Note that when the 4×4 coding unit 104 was decoded, the CtDepth value 0 had to be filled into a 4×4 region of the memory. As yet unprocessed coding unit positions are marked as ‘-’.

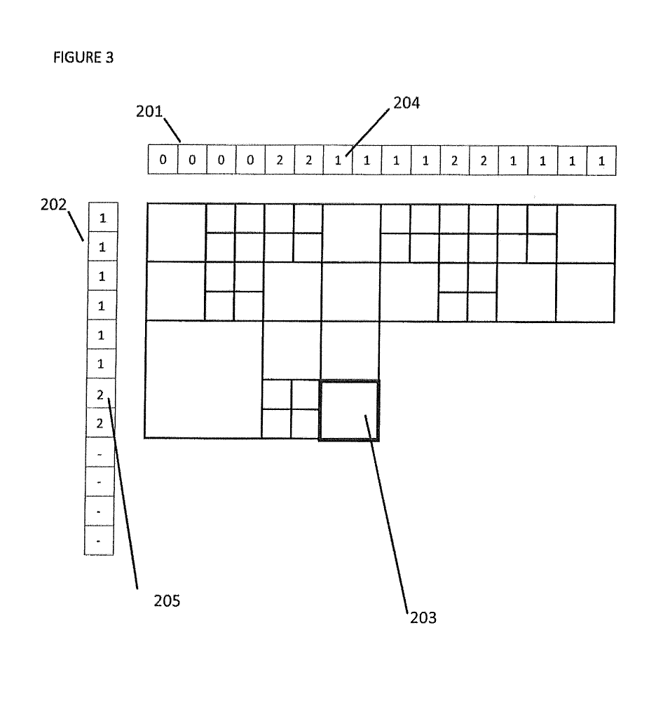

FIG. 3 shows a CtDepth memory implementation according to an embodiment of the present invention. The same video frame structure and CtDepth values of FIG. 2 are depicted. Instead of a 2-D memory of CtDepth values, two one-dimensional (1-D) memory arrays are used. A horizontal array 201 contains the down-most available CtDepth values in each coding unit column. A vertical array 202 contains the right-most available values in each coding unit row. Coding unit 203 is currently being decoded. The CtDepth values of its above and left neighbours are available in entries 204 and 205 respectively. In the more general case, when the coding or decoding process is at coding location (x, y) and it requires a value from the coding unit at location (x−1, y), that value is retrieved from vertical array 202 entry y. Similarly, when a value from the CU at location (x, y−1) is needed, the value is retrieved from horizontal array 201 entry x. As yet unfilled array positions are marked as ‘-’. It can be seen that the horizontal array 201 has been populated with values at all positions, and that the vertical array 202 only has a small number of empty positions which correspond to rows of blocks for which no blocks have yet been processed. From a comparison with FIG. 2 it can be readily appreciated that the number of stored values, and thus the amount of memory used, is much less in FIG. 3 than in FIG. 2.

Here the terms “vertical” and “horizontal” are used for the purposes of description only and do not reflect the actual orientation or implementation of these 1-D arrays. Preferred embodiments will implement both arrays as conventional, contiguous data arrays in memory with a linear address space. This enables efficient read and write operations for storing and retrieving parameter values into the memory.

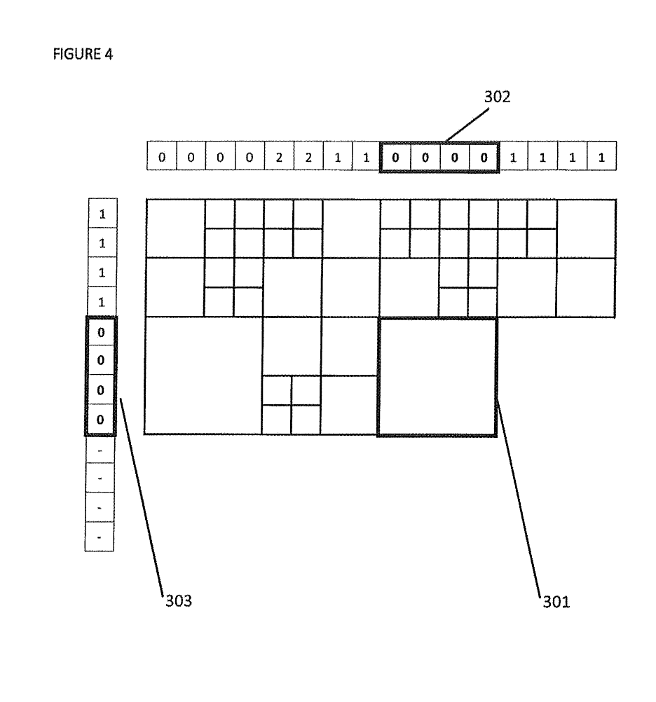

FIG. 4 shows a large coding unit 301 being processed according to an embodiments of the present invention. When a region's CtDepth value becomes available, the lowest available values stored in the horizontal array and the rightmost available values stored in the vertical array must be updated. Such an update process is applied subsequent to a block's CtDepth value being known. The update process fills the new value into regions of the 1-D memory corresponding to the block's location relative to the 1-D arrays' spans. In this example, the newly decoded coding unit's CtDepth value, zero, is populated into the appropriate horizontal 1-D array region 302 and vertical 1-D array region 303. In the general case, when CtDepth of a coding unit whose top-left and bottom-right blocks are at (x1, y2) and (x2, y2) inclusive is known, the update process fills the CtDepth value into horizontal array entries x1 . . . x2 and vertical array entries y1 . . . y2.

It will be appreciated from FIGS. 3 and 4 that different sizes of coding unit can be handled, and that as a result different numbers of elements of the first and second arrays may need to be populated with parameter values depending on the size of the coding unit being processed. For example, processing of the 2×2 coding unit 203 of FIG. 3 will require two elements of each of the horizontal and vertical arrays to be populated with the resulting parameter value, while processing of the 4×4 coding unit 301 of FIG. 4 will require 4 elements each of the horizontal and vertical arrays to be populated with the resulting parameter value.

This 1-D memory is applicable for parameter values other than CtDepth. Any parameter value resulting from processing one coding unit and required to process another coding unit could be stored in the one dimensional arrays. This includes pixel values of an image, where they are generated from one coding unit and required as a parameter for another coding unit. For example, during HEVC slice processing, the following information is needed from previously processed, adjacent CUs: cu_skip_flag, pcm_flag, CtDepth and CuPredMode, each of which can be stored in the manner described above. In some cases different parameters apply at different levels of resolution. For example, the parameter IntraPredictionMode is needed at double the coding unit resolution, requiring twice as many elements in each array. Some embodiments may store CtDepth at half the coding unit resolution, requiring only half the number of elements in each array (although the same number could be used instead, with either skipped array elements or duplication in two array elements). Within a HEVC CTU, QpY can be stored this way with a resolution set on a per image basis in dependence on the parameter CuQpDeltaSize.

According to a preferred embodiment, multiple values may be stored in a structure at each 1-D array entry. For example, the values cu_skip_flag, pcm_flag, CtDepth and CuPredMode can be aggregated by coding unit and stored in each entry. This has the advantage of improving memory access patterns and cache performance, since multiple parameter values can be stored at sequential addresses in memory and retrieved as a single operation. It will be appreciated that where different parameters are stored at different resolutions, it may be necessary or beneficial to store these in separate arrays, such that each array is optimised for the resolution of the parameters which it stores.

The horizontal and vertical arrays may span the entire width or height, respectively of the video picture. In other implementations, these arrays may span only the current slice or tile being processed. In the case of coding standards using a raster scan of CTU or macroblock rows, it may be advantageous to arrange the vertical 1-D array with a height sufficient to span only a single CTU row. In this case, at the start of each CTU row, the vertical array can be reinitialized.

In some cases, it is necessary to supplement the horizontal and vertical 1-D memory arrays with a local memory array. This makes it possible to store and retrieve further local values in addition those available from the 1-D arrays. The IntraPredictionMode variable in HEVC is one such case which may require additional temporary local storage. Furthermore, use of this invention does not preclude duplicate storage of the same information in another form, for example, for downstream processes such as deblocking that may operate at a later time.

Some video codec operations may require values from the block to the top-left of the current block. Such data values are not available from either the horizontal or vertical 1-D memory array described previously. According to some embodiments of the present invention, the top-left, or “corner” block can be stored in a third “corner” 1-D array. This third array may either be horizontal or vertical and is populated when top-left values become “hidden” when new blocks are written. It may have a different size to its parallel horizontal or vertical 1-D array.

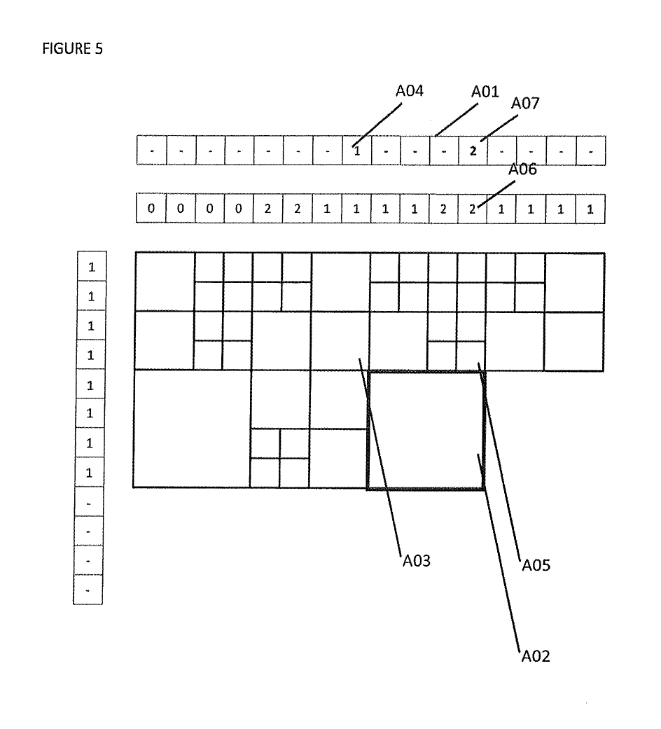

FIG. 5 shows an exemplary implementation with a “corner” 1-D array A01. The corner array stores data pertaining to top-left neighbour blocks. Because this information is only important when there exist top-left corners in the processing front, this is depicted as a sparse array. In this figure, block A02 is being processed and data from its top-left neighbour A03 is unavailable from either the horizontal or vertical 1-D array. The top-left data was stored previously in the corner 1-D array at location A04. The block A02 is therefore able to be properly processed even though the parameter data from the block A03 is no longer present in either the horizontal or vertical 1-D memory.

After the current block A02 is processed, data from block A05 will be erased from the horizontal 1-D array when the current block's data are written there. So, after block A02 is processed and before its new data are written into the horizontal and vertical 1-D arrays, the corner value at location A06 is written to location A07 in the corner 1-D array. Likewise, every time writing a new block's data to the horizontal and vertical arrays would erase corner data that may be needed for future blocks, that corner data is copied to the corner 1-D array.

An important attribute of some embodiments of this invention is the facility to handle unavailable blocks (such as blocks outside of the extent of the image, or blocks from a previous slice or tile, which are not intended to provide parameter values for the processing of blocks of an independent slice or tile) by setting appropriate initial values in appropriate locations in the memory. This helps avoid computing availability conditions. For example, HEVC defines ctxlnc for split_cu_flag thusly:

ctxlnc=(condL && availableL)+(condA && availableA)

where condL=CtDepthL>cqtDepth

and condA=CtDepthA>cqtDepth

Here CtDepthA and CtDepthL are the values of CtDepth of neighbouring coding units above and to the left, respectively, of the current coding unit. The variables availableA and availableL represent the availability of neighbouring coding units above and to the left, respectively, of the current coding unit. These availability values are defined as 1 when the neighbouring coding unit is within the same slice and tile as the current coding unit and 0 when the neighbouring coding unit is in a different slice or tile (or not in the image at all) and thus unavailable. It will be appreciated that, in processing a block with respect to ctxlnc, that it will be necessary to make a determination as to whether or not the left and above blocks are available, which may be computationally expensive. As a result, embodiments of the present invention set elements in a parameter memory to a value which obviates the requirement, when processing a current block of image data, to test whether an adjacent block of image data exists within the image, or within an independently processable region of the image currently being processed.

In preferred embodiments of this invention, an initialization process makes extra, initial values of CtDepth available to the ctxlnc computation process such that availability does not need to be checked, thus obviating the need to perform a computationally expensive operation. These initial values are set in the memory at locations representing the unavailable blocks. The initial value is selected so that condL and condA return a value which results in ctxlnc in turn returning the same value as would be the case if availableL and availableA were to be determined. In other words, by setting the initial values appropriately, there is no need to evaluate availableL and availableA.

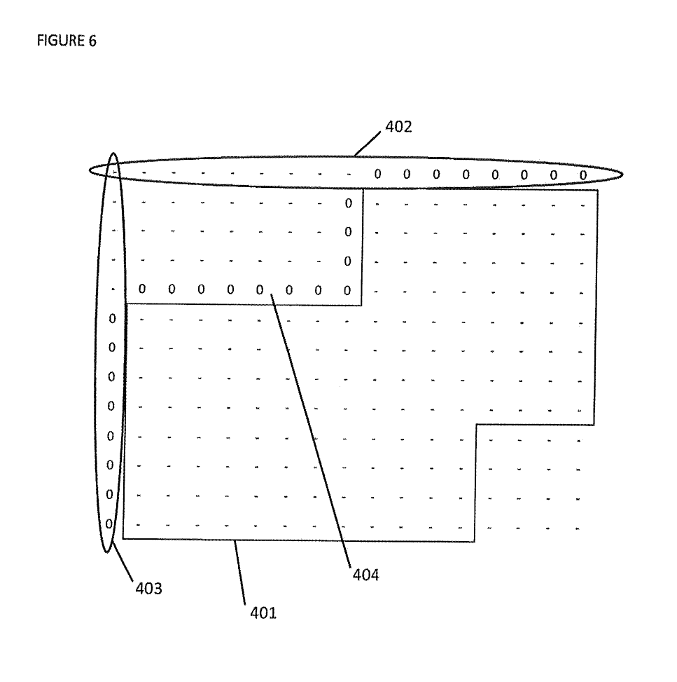

FIG. 6 shows this invention embodied using a 2-D memory array. The memory is depicted after the initialization process but immediately prior to decoding a slice 401. Additional array locations above 402 and to the left 403 of the main region of 2D parameter memory are provided. These additional locations do not correspond to real portions of the image, but correspond instead to imaginary lines of image blocks along the left hand side and top of a real image. Values of CtDepth at block locations to the immediate left and above the slice boundaries are initialized with a zero value 404. This applies both to the additional array locations, and also to locations of the memory which are adjacent to the slice about to be processed but which correspond to a previous slice or tile. Any value equal to or less than the minimum value of cqtDepth could equally be used instead in alternate embodiments.

When the left coding unit is unavailable, CtDepthL is retrieved from an initialized memory location as zero. This results in a CtDepthL value of zero. Because cqtDepth cannot be less than zero, condL evaluates to zero also. Thus availableL has no effect on the value of ctxlnc and does not need to be computed. The same is true of condA and availableA. By setting at least memory locations representing CtDepth of unavailable blocks to zero the need to compute slice and tile block availability is removed. Computation of ctxlnc for split_cu_flag is the same whether a block is adjacent to a slice or tile boundary or not.

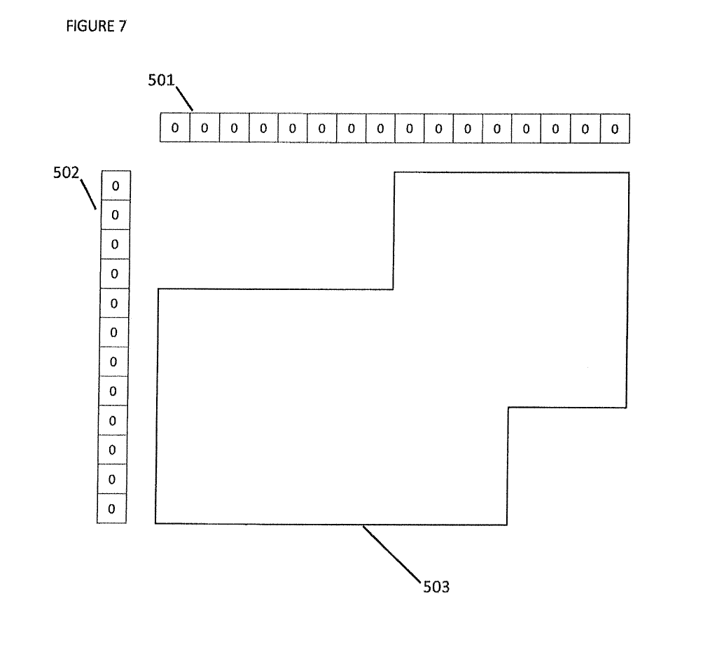

FIG. 7 shows another embodiment of this invention using horizontal 501 and vertical 502 1-D arrays. Here again, memory state is shown after the initialization process but prior to decoding a slice 503. When computing ctxlnc for split_cu_flag of blocks adjacent to upper and left boundaries of the slice, a zero CtDepth value is retrieved from the memory. By setting every value in both horizontal and vertical 1-D arrays to zero before decoding a slice or tile, it becomes unnecessary to check availability conditions avoiding the need for complex additional logic. Unlike the 2D example, with this embodiment there is no need to provide additional array elements specifically associated with imaginary blocks outside of the image area.

This technique to avoid boundary computation is equally applicable, by selecting appropriate initial values, to other computations involving boundary logic in compressed video processing. In other words, different parameters can be handled in this way. The initial values for each parameter to obviate neighbouring block availability checking may differ, depending on the computation carried out in relation to that parameter. For example, it may be applied to ctxlnc computation for cu_skip_flag in HEVC by initializing appropriate values in cu_skip_flag memory. Two further examples are outlined below.

### Example 2

HEVC defines ctxlnc for cu_skip_flag thusly:

ctxlnc=(cu_skip_flagL && availableL)+(cu_skip_flagA && availableA)

Where cu_skip_flagL is the parameter value of the left neighbor and cu_skip_flagA is the parameter value of the above neighbor.

In this case, by initializing “phantom”/unavailable neighbor values of 0 for cu_skip_flagL and cu_skip_flagA, there is never a need to compute availableA and availableL and the derivation of ctxlnc for cu_skip_flag is simplified to:

ctxlnc=cu_skip_flagL+cu_skip_flagA

### Example 3

The predicted luma quantization parameter qPY_PRED is derived as follows:

qPY_PRED=(qPY_{—}A+qPY_{—}B+1)>>1
If the left neighbor block is available, qPY_A is set to the that neighbor block's parameter value QPY, otherwise it is set to a previously computed value qPY_PREV
If the above neighbor block is available, qPY_B is set to the that neighbor block's parameter value QPY, otherwise it is set to a previously computed value qPY_PREV

In this case, by initializing QPY value array entries by filling with the value of qPY_PREV, the conditions in the bullets above can be avoided and qPY_PRED becomes a simple function of the neighbour values.

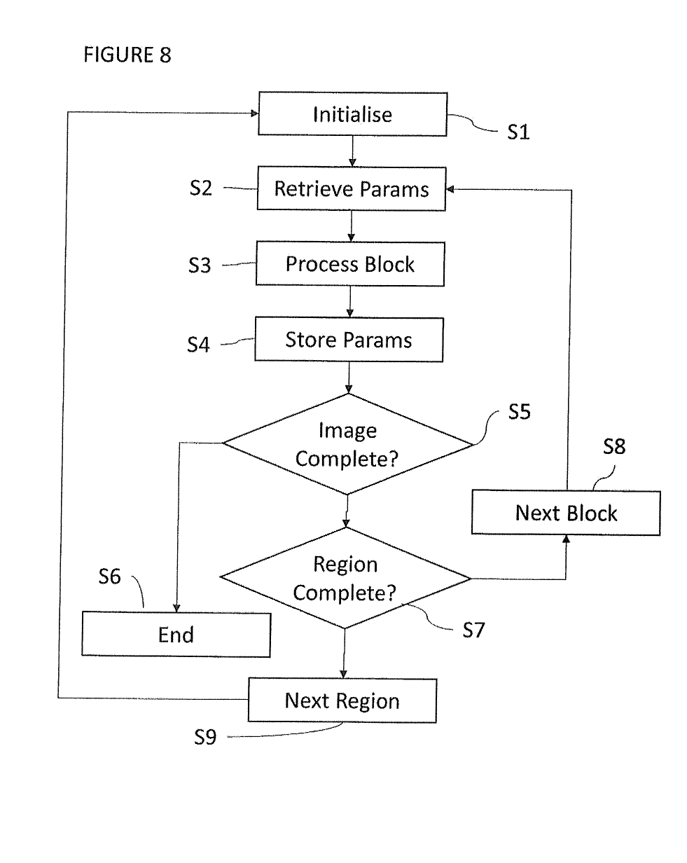

The overall process of parameter handling, using both 1D parameter memory arrays and initialisation, is summarised in FIG. 8, which sets out broadly the steps involved, starting from when processing of an image is initiated. At a step S1, the two 1D memory arrays are initialised to an appropriate value which will avoid the need for a determination to be made as to whether any particular block has an available neighbour. As discussed above, the specific value chosen will depend on the parameter being handled, and the computational logic applied to that parameter. When processing of a current block of image data is to be conducted, then at a step S2 appropriate parameter values are retrieved from the horizontal and/or diagonal and/or corner memory arrays. For example, if a current block requires a parameter generated from processing blocks above and to the left of the current block, parameter values will be obtained from both the horizontal memory array, and the vertical memory array. At a step S3, the current block is processed using the retrieved parameter values. The processing of the current block may generate a new parameter value. At a step S4, the new parameter value is stored into one or (usually) both of the horizontal and vertical memory arrays at positions corresponding to the position of the current block. If there is already data in one or both of the horizontal and vertical memory arrays, this may involve overwriting the existing data. In most cases this will not be a problem because that data will no longer be required for processing future blocks. However, where the data to be overwritten will be required for future processing of a block (for example a block which is diagonally below and to the right of the block from which the data was generated) then the data is copied into a corner array prior to being overwritten. At a step S5, it is determined whether processing of the image is complete. If so, then at a step S6 the process comes to an end. Otherwise, it is determined at a step S7 whether the current independently processable region (e.g. slice or tile) is complete. If so, then at a step S9 processing is moved on to the next region, starting with the reinitialisation of the parameter memory at the step S1. Otherwise, at a step S8 the next block is processed, starting with the retrieval of the required parameters at the step S2. It will be understood that the flow diagram does not contain any steps relating to the determination of whether an adjacent block is available within the region. This is because the initialisation step S1 sets the memory array elements to a value which removes the need for such a step, as discussed above. It will be appreciated that the steps of FIG. 8 only relate to the processing of a single parameter. However, the same steps can be applied to the processing of other parameters, as needed, and multiple parameters can be conveniently stored together in the one dimensional parameter memory arrays.

Although the above description contains significant exemplary detail, it should not be taken to narrow the scope of this invention which applies also to spatial neighbour information memory and boundary availability logic in existing and potential future video decoders, encoders and other processing devices.

1. An image processing method, comprising:
processing a current block of one or more pixels of image data and generating a parameter value required to process one or both of a horizontally adjacent block of image data and a vertically adjacent block of image data; and
storing the parameter value into a parameter memory, the parameter memory comprising a memory element for each of a plurality of horizontal block positions in an image, and a memory element for each of a plurality of vertical block positions in the image, wherein a parameter value generated from a block of image data is stored to overwrite one or both of a previous parameter value generated from another block of image data at the same horizontal position as the current block, and a previous parameter value generated from another block of image data at the same vertical position as the current block.

2. An image processing method according to claim 1, wherein the step of storing comprises storing the parameter value into a first one dimensional memory array and a second one dimensional memory array of the parameter memory, the parameter value being stored into the first one dimensional memory array at one or more positions corresponding to the horizontal position of the current block, and being stored into the second one dimensional memory array at one or more positions corresponding to the vertical position of the current block.

3. An image processing method according to claim 2, wherein the horizontal position of the current block is its horizontal position within an image or within a portion of the image, and the vertical position of the current block is its vertical position within the image or within the portion of the image.

4. An image processing method according to claim 2, comprising the step of:
retrieving a parameter value corresponding to a previously processed block which is vertically adjacent to the current block from the first one dimensional memory array and/or retrieving a parameter value corresponding to a previously processed block which is horizontally adjacent to the current block from the second one dimensional memory array; and
wherein the current block of image data is processed using the parameter value(s) retrieved from the first one dimensional memory array and/or the second one dimensional memory array.

5. An image processing method according to claim 2, comprising the step of:
retrieving a parameter value corresponding to a previously processed block which is diagonally adjacent to the current block from the first one dimensional memory array or the second one dimensional memory array; and
wherein the current block of image data is processed using the parameter value retrieved from the first or second one dimensional memory array.

6. An image processing method according to claim 2, wherein the step of storing the parameter value generated from the processing of the current block comprises overwriting in the first one dimensional memory array a previously stored parameter value which corresponds to a previously processed block at the same horizontal position as the current block, and overwriting in the second one dimensional memory array a previously stored parameter value which corresponds to a previously processed block at the same vertical position as the current block.

7. An image processing method according to claim 2, wherein the first one dimensional memory array and the second one dimensional memory array are each implemented as contiguous data arrays in memory using contiguous address space.

8. An image processing method according to claim 2, wherein the first one dimensional memory array and the second one dimensional memory array are each sized to store parameter data for an independently processable region of an image.

9. An image processing method according to claim 1, wherein the second one dimensional memory array is sized to store parameter data for a single row of blocks of the largest block size being processed by the method.

10. An image processing method according to claim 2, wherein
the method can process blocks of different sizes;
each element of the first one dimensional memory array and the second one dimensional memory array corresponds to an image area of size equivalent to the highest common factor of all the block sizes which can be processed by the method; and
if the current block is larger than the smallest block size then the parameter values generated by processing the current image block are stored into a plurality of positions within the first and second one dimensional memory arrays which correspond to the position of the current image block.

11. An image processing method according to claim 2, wherein when a parameter value within one or both of the first and second one dimensional memory arrays is to be overwritten, if the parameter value to be overwritten would subsequently be required in order to process a block which is diagonally adjacent to the block from which the parameter value was generated, the parameter value is copied to a third memory array before being overwritten in the first and/or second one dimensional memory arrays.

12. An image processing method according to claim 11, wherein the third memory array is a one dimensional memory array having memory positions which correspond to the horizontal or vertical position of the image block from which the parameter value to be stored in the third memory array was generated.

13. An image processing method according to claim 2, wherein
the blocks are processed in a raster scan order,
the first one dimensional memory array stores parameter values corresponding to a bottom-most processed block at each horizontal position, and the second one dimensional memory array stores parameter values corresponding to a right-most processed block at each vertical position,
a parameter value corresponding to an image block immediately above the current image block is retrieved from the first one dimensional memory array at a position corresponding to the current image block, and
a parameter value corresponding to an image block immediately to the left of the current image block is retrieved from the second one dimensional memory array at a position corresponding to the current image block.

14. An image processing method according to claim 1, wherein each element of the parameter memory stores a plurality of parameter values corresponding to a plurality of different parameters.

15. An image processing method according to claim 1, comprising a step of initializing elements of the parameter memory with a predetermined parameter value before they are used for processing an independently processable region of an image.

16. An image processing method according to claim 15, wherein in the initialization step, the same predetermined parameter is written to all elements of the parameter memory independently of the actual parameter values generated from the blocks of image data which those elements correspond to.

17. An image processing method according to claim 16, wherein the predetermined value is below a minimum possible value for the parameter, or above a maximum possible value for the parameter, or an impermissible value for the parameter, or a null or zero value, or a default value for the parameter, or a previously computed value for the parameter which applies when a block in a new independently processable region of the image is at a border of that region.

18. An image processing apparatus, comprising:
a processor operable to process a current block of one or more pixels of image data and to generate a parameter value required to process one or both of a horizontally adjacent block of image data and a vertically adjacent block of image data; and
a parameter memory, comprising a memory element for each of a plurality of horizontal block positions in an image, and a memory element for each of a plurality of vertical block positions in the image, wherein the parameter memory is configured when storing a parameter value generated from a block of image, to overwrite one or both of a previous parameter value generated from another block of image data at the same horizontal position as the current block, and a previous parameter value generated from another block of image data at the same vertical position as the current block.

19. An image processing method, comprising:
initializing to a predetermined value one or more elements of a parameter memory;
in relation to the processing of a current block of image data, retrieving a parameter value from the parameter memory and processing the current block of image data using the retrieved parameter; wherein
the retrieved parameter value is either a value generated from the processing of a spatially adjacent block in a particular direction with respect to the current block, or the initialized predetermined value in a case where there is no spatially adjacent block available in that particular direction within the image or within an independently processable region of the image currently being processed.

20. An image processing method according to claim 19, wherein
the parameter memory comprises a two dimensional array of elements having a main part in which each element corresponds to a block of image data in an image, and a border part comprising a row of elements vertically adjacent to the main part and a column of elements horizontally adjacent to the main part; and
one or more elements within the border part are initialized in order to permit the processing of a block of pixels at an edge of the image and/or one or more elements within the main part, at a position corresponding to blocks of image data outside of the independently processable region of the image currently being processed, are initialized in order to permit the processing of a block of pixels at an edge of the independently processable region of the image which is adjacent to another independently processable region of the image.
